(19) United States
(12) Patent Application Publication
(10) Pub. No.: US 2009/0085733 A1
(43) Pub. Date: Apr. 2, 2009

(54) Tire pressure, speed and acceleration monitoring system and method

(75) Inventors: Shrikant Gandhi, Colorado Springs, CO (US); Kis Charles, West Bend, WI (US)

Correspondence Address: LAW OFFICE OF DALE B. HALLING, 3595 FOUNTAIN BOULEVARD SUITE A2, COLORADO SPRINGS, CO, 80910, US

(73) Assignee: Kisan Technologies, Inc.

(21) Appl. No.: 12/220,113

(22) Filed: Jul. 22, 2008

Related U.S. Application Data
(60) Provisional application No. 60/995,550, filed on Sep. 27, 2007.

(51) Int. Cl. B60C 23/00

(52) U.S. Cl. 340/443

(57) ABSTRACT

The tire pressure, speed and acceleration monitoring system of the present invention has a transducer mounted to the wheel of a motor vehicle and a controller mounted to a non-rotating part of the vehicle. The transducer is passive and receives its power from an interrogation signal from the controller. The transducer replies with a pressure signal. The tire pressure may be frequency encoded. This is accomplished by having a resonant circuit whose resonant frequency depends on the tire pressure. Speed and acceleration are calculated by determining when the transducer passes the receiver of the controller. Since the range of the transducer is very limited, the transducer will only respond to an interrogation signal when the transducer is next to the controller receiver. The transducer has a tire pressure fill valve.

### BACKGROUND OF THE INVENTION

In motor vehicles, including motorcycles, it is important to have tires properly inflated. Under inflated tires can decrease gas mileage, cause premature wearing on the tire and effect cornering capabilities. Over inflated tires can cause a rough ride, uneven wear of tire tread and less surface contact in stopping and turning situations. As a result, there has been an initiative to include tire pressure monitoring devices in motor vehicles. However, most of the present efforts are for new motor vehicles or require complex time consuming installation procedures.

Thus there exists a need for a tire pressure monitoring system that can be easily installed in existing motor vehicles.

### BRIEF SUMMARY OF INVENTION

A tire pressure, speed and acceleration monitoring system that overcomes these and other problems has a transducer mounted to the wheel of a motor vehicle and a controller mounted to a non-rotating part of the vehicle. The transducer is passive and receives its power from an interrogation signal from the controller. The transducer replies with a pressure signal. In one embodiment the tire pressure is frequency encoded. This is accomplished by having a resonant circuit whose resonant frequency depends on the tire pressure. Speed and acceleration are calculated by determining when the transducer passes the receiver of the controller. Since the range of the transducer is very limited, the transducer will only respond to an interrogation signal when the transducer is next to the controller receiver. The transducer has a tire pressure fill valve so that it can replace the valve stem of a tire or fit over an existing valve stem for easy installation.

### BRIEF DESCRIPTION OF THE SEVERAL VIEWS OF THE DRAWINGS

FIG. 1 is a drawing of a motorcycle with a tire pressure, speed and acceleration monitoring system in accordance with one embodiment of the invention;

FIG. 2 is a block diagram of a tire pressure, speed and acceleration monitoring system in accordance with one embodiment of the invention;

FIG. 3 is a block diagram of an interrogation signal being sent to the transducer in accordance with one embodiment of the invention; and

FIG. 4 is a block diagram of a response signal being sent from the transducer to the controller in accordance with one embodiment of the invention.

### DETAILED DESCRIPTION OF THE INVENTION

The tire pressure, speed and acceleration monitoring system of the present invention has a transducer mounted to the wheel of a motor vehicle and a controller mounted to a non-rotating part of the vehicle. The transducer is passive and receives its power from an interrogation signal from the controller. The transducer replies with a pressure signal. In one embodiment the tire pressure is frequency encoded. This is accomplished by having a resonant circuit whose resonant frequency depends on the tire pressure. Speed and acceleration are calculated by determining when the transducer passes the receiver of the controller. Since the range of the transducer is very limited, the transducer will only respond to an interrogation signal when the transducer is next to the controller receiver. The transducer has a tire pressure fill valve so that it can replace the valve stem of a tire or fit over an existing valve stem for easy installation.

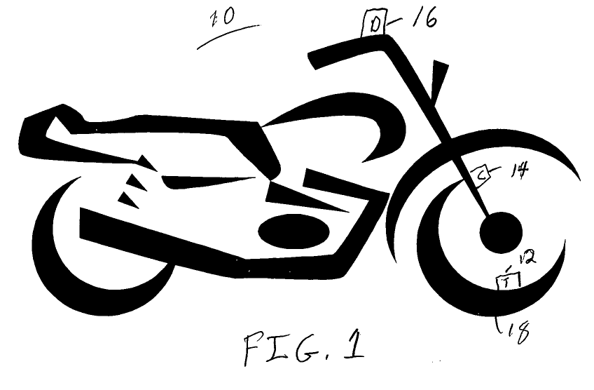

FIG. 1 is a drawing of a motorcycle 10 with a tire pressure, speed and acceleration monitoring system in accordance with one embodiment of the invention. The system has three main components, a pressure transducer 12, a controller 14 and a display 16. The transducer 12 is attached to the tire 18 of the motorcycle or other motor vehicle. The transducer 12 measures the pressure of the tire 18. A controller 14 receives a wireless pressure signal from the transducer 14. The controller 14 then transmits the pressure reading to the display 16. Note that the transducer 12 is passive, meaning that it is not battery powered or wired to a power source but receives its power from a wireless interrogation signal from the controller 14. The controller 14 detects how often the transducer 12 goes past it and uses the time intervals to measure the speed and acceleration of the vehicle.

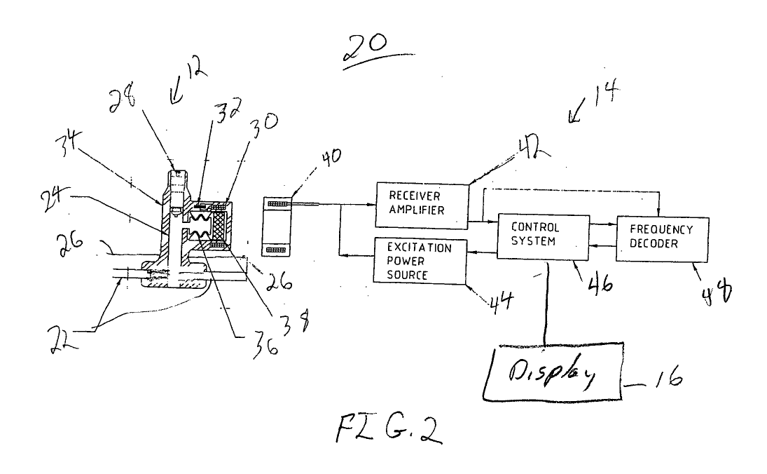

FIG. 2 is a block diagram of a tire pressure, speed and acceleration monitoring system 20 in accordance with one embodiment of the invention. The three main components are the transducer 12, the controller 14 and the display 16. The transducer 12 is attached to the tire of the motor vehicle and has an inlet 22 in the tire that couples the tire pressure to a connection port 24. The tire is represented by line 26. At the other end of the connection port 24 is a standard tire pressure fill valve 28. In order to sense the tire pressure the transducer 12 has an inductive element 30 and a capacitive element 32 that form a resonant circuit. The resonant frequency of such a circuit is a function of the inductance and capacitance of the circuit elements. By having inductive and/or capacitive elements that change with pressure, the resonant frequency will change with pressure. If the resonant frequency is measured then the pressure can be correlated with a specific resonant frequency. By using elements that change with temperature, it is possible to compensate for the temperature related tire pressure change by offsetting the pressure changes with a temperature change. In the embodiment shown, the inductive coil 30 is mounted at one end to the transducer body 34 and at the other end is mounted to a bellows 36. The connection port 24 connects the bellows 36 to the inside of the tire and therefore the tire pressure. The bellows 36 changes in length in response to changes in tire pressure. This results in changes in distance between the coil core 38 and the inductive coil 30, which changes the inductance of the resonant circuit. Changes in the inductance of the resonant circuit results in changes in the resonant frequency of the resonant circuit. The relationship between the resonant frequency and the tire pressure can be calibrated to determine the tire pressure.

The controller 14 has a stationary coil 40, which acts as an antenna. The stationary coil 40 is connected to a receiver amplifier 42 and an excitation power source 44. The receiver amplifier 42 and the excitation power source 44 are controlled by a control system 46. The control system 46 is connected to the display 16 and a frequency decoder 48.

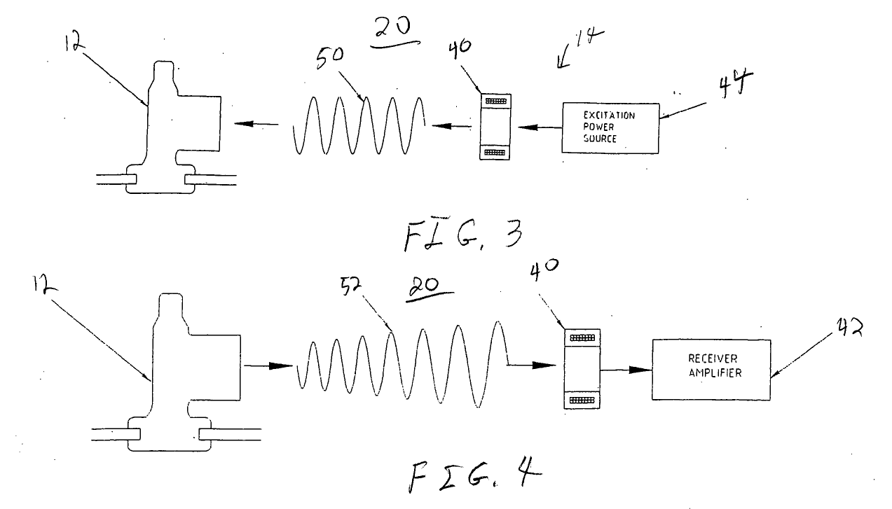

The operation of the system 20 will be described with respect to FIGS. 3 & 4. FIG. 3 is a block diagram of an interrogation signal 50 being sent to the transducer 12 in accordance with one embodiment of the invention. The transducer 12 is completely passive and only receives power wirelessly from the controller 14. The controller 14 has the excitation power source 44 initiate and interrogation pulse by applying a time varying signal to the stationary coil 40. This results in a interrogation pulse 50, which is a time varying magnetic field. When the transducer 12 is sufficiently close to the controller 14, the transducer's resonant circuit 30, 32 will have an excitation current generated. Upon removal of the interrogation pulse's external field, the resonant circuit 30, 32 of the transducer 12 will continue to resonate. This will result in a response signal 52, see FIG. 4. The response signal 52 is a wireless signal with a frequency that depends on the resonant frequency of the resonant circuit. The response signal 52 is received by the stationary coil 40 and receiver amplifier 42. The response signal after amplification is sent to the frequency decoder 48, which determines the frequency of the response signal. The frequency information is sent to the control system 46, which determines the tire pressure. The tire pressure can then be sent to the display 16 for viewing.

The range of resonant frequencies of the transducer 12 due to the tire pressure is limited, and the frequency of the exciting magnetic field 50 is fixed near the resonant frequency of the transducer 12. This results in maximum excitation of the transducer 12 for a given coil current, thus increasing the operating range and reducing the time the resonant circuit has to attain adequate power. This is helpful because the transducer 12 will only be near the stationary coil 40 for a short period of time at high speeds.

During the initial acquisition stage, the angular location of the transducer 12 relative to the stationary coil 40 is unknown. At this stage the interrogation pulse 50 is transmitted at a high repetition rate, as high as 10,000 repetitions per second. Upon the first time detection of the response signal 50, a timer function is enabled by the control system 46 to measure the period between successive detections. This allows the speed of the vehicle and its acceleration to be calculated.

Thus there has been described a tire pressure monitoring system that can be easily installed in existing motor vehicles. Note that while the invention has been describe with an inductive element whose inductance changes with the tire pressure, it will be apparent to those skilled in the art that the resonant circuit could have a capacitive element whose capacitance changes with the tire pressure.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A tire pressure, speed and acceleration monitoring system, comprising:
a transducer mounted to a wheel, the transducer receiving power wirelessly and transmitting a pressure signal;
a controller receiving the pressure signal.

2. The system of claim 1, wherein the controller transmits power wirelessly to the transducer.

3. The system of claim 1, wherein the pressure signal is frequency encoded.

4. The system of claim 3, wherein the transducer has a resonant circuit with a resonant frequency that is dependent upon a pressure of a tire.

5. The system of claim 4, wherein the resonant frequency of the transducer adjusts for temperature changes.

6. The system of claim 1, wherein the controller determines a speed based on a time between responses from the transducer.

7. The system of claim 1, wherein the transducer has a tire pressure fill valve.

8. A method of operating a tire pressure, speed and acceleration monitoring system, comprising the steps of:
a) transmitting an interrogation signal from a controller;
b) receiving the interrogation signal at a transducer on a rotating wheel;
c) powering the transducer using the interrogation signal.

9. The method of claim 8, further including the step of:
d) transmitting a response signal from the transducer to the controller.

10. The method of claim 8, wherein the step of transmitting the response signal includes transmitting a pressure signal.

11. The method of claim 10, wherein the step of transmitting the pressure signal includes the step of frequency encoding a tire pressure.

12. The method of claim 8, wherein the step of transmitting the interrogation signal is repeated until a response signal is received.

13. The method of claim 12, further including the step of once at least two response signals are received estimating a time for transmitting a next interrogation signal.

14. The method of claim 13, further including the step of estimating a speed based on a time differential between response signals.

15. The method of claim 14, further including the step of estimating an acceleration based on the speed measurements.

16. A tire pressure, speed and acceleration monitoring system, comprising:
a controller having an acquisition algorithm transmitting an interrogation signal; and
a transducer mounted to a wheel transmitting a response signal when the interrogation signal is received.

17. The system of claim 16, wherein the controller has a speed estimation algorithm that determines a speed based on a time interval between a pair of response signals.

18. The system of claim 16, wherein the transducer is passive.

19. The system of claim 18, wherein the response includes a pressure signal.

20. The system of claim 16, wherein the pressure transducer includes a tire pressure fill valve.
